(19) United States
(12) Patent Application Publication
(10) Pub. No.: US 2026/0161059 A1
(43) Pub. Date: Jun. 11, 2026

(54) CAMERA FINGER GRIP

(71) Applicant: TILTA INC., Burbank, CA (US)

(72) Inventors: Shujin FU, Shenzhen (CN); Wenping ZENG, Shenzhen (CN); Kefeng ZHOU, Shenzhen (CN)

(21) Appl. No.: 19/360,785

(22) Filed: Oct. 16, 2025

(30) Foreign Application Priority Data
Oct. 19, 2024 (CN) 202422536532.9

(51) Int. Cl. G03B 17/56

(52) U.S. Cl. CPC G03B 17/563

(57) ABSTRACT

A camera finger grip includes: a mounting part designed for attachment to a camera; a connecting part, with its front side connected to the mounting part and its rear side featuring a first contact surface inclined towards the mounting part; and a tail end part, fixedly positioned at the end of the connecting part away from the mounting part, with its rear side presenting a second contact surface inclined away from the mounting part, where the first and the second contact surfaces are interconnected. The synergy between the second and the first contact surfaces is tailored to better accommodate the user's finger shape, offering enhanced support to fingers and improving user comfort.

### CROSS-REFERENCE TO RELATED APPLICATION

The present application for patent claims priority to and the benefit of pending Chinese Application No. 2024225365329, filed October 19, 2024, and hereby expressly incorporated by reference herein as if fully set forth below in its entirety and for all applicable purposes.

### TECHNICAL FIELD

The present application pertains to the field of camera accessories, more particularly to a camera finger grip.

### INTRODUCTION

When operating a camera, to meet the need for a comfortable grip for the user, a camera finger grip is often installed to provide a resting place for the thumb. For instance, a camera finger grip can include a grip body with a fixture block for attachment to a camera hot shoe. The right end of the grip body bends backward and downward at an angle of 16 to 22 degrees, featuring an arc-shaped transitional section at the bend. However, this type of camera finger grip has limitations. In particular, the junction between the grip body and the bent surface is formed as a vertically oriented planar structure. Given the normal usage posture where the thumb rests diagonally against the camera finger grip, this vertically oriented planar structure does not conform well to the user's thumb, thereby affecting ergonomic comfort during use.

### BRIEF SUMMARY

Aspects of the present disclosure provide a camera finger grip that better adapts to the finger of the user when resting diagonally thereon, thereby enhancing user comfort.

Some aspects of, the present disclosure provide:

A camera finger grip, including:

a mounting part for attachment to a camera;

a connecting part, with its front side connected to the mounting part and its rear side presenting a first contact surface inclined towards the mounting part;

a tail end part, fixedly positioned at the end of the connecting part opposite the mounting part, featuring a second contact surface inclined away from the mounting part, where the first and the second contact surfaces are interconnected.

The camera finger grip is attached to the camera via the mounting part. When the user operates the camera, their finger can slide over the second contact surface of the tail end part and rest diagonally on the first contact surface. Through the synergy of the second and the first contact surfaces, the camera finger grip better conforms to the user's finger shape, providing superior support to fingers and enhancing user comfort.

### BRIEF DESCRIPTION OF THE DRAWINGS

FIG. 1 is a schematic diagram of a camera finger grip from a first perspective according to some aspects of the present disclosure.

FIG. 2 is a schematic diagram of the camera finger grip from a second perspective according to some aspects of the present disclosure.

FIG. 3 is a schematic diagram illustrating the camera finger grip mounted on a camera according to some aspects of the present disclosure.

FIG. 4 is a schematic diagram illustrating the camera finger grip and a top plate mounted on the camera from a first perspective according to some aspects of the present disclosure.

FIG. 5 is a schematic diagram illustrating the camera finger grip and the top plate are mounted on the from a second perspective camera according to some aspects of the present disclosure.

### Reference Numerals Used in Drawings

1. Mounting part; 11. Threaded hole; 12. Sliding groove;

2. Connecting part; 21. First contact surface; 22. Clearance groove; 221. Inclined surface; 222. Curved surface;

3. Tail end part; 31. Second contact surface;

4. Contoured contact surface;

5. Camera; 51. Lens; 52. Control element; 53. Camera hot shoe interface;

6. Top plate; 61. Upper side plate; 62. Fixing position; 63. Second holding hole; 64. Third contact surface.

### DETAILED DESCRIPTION

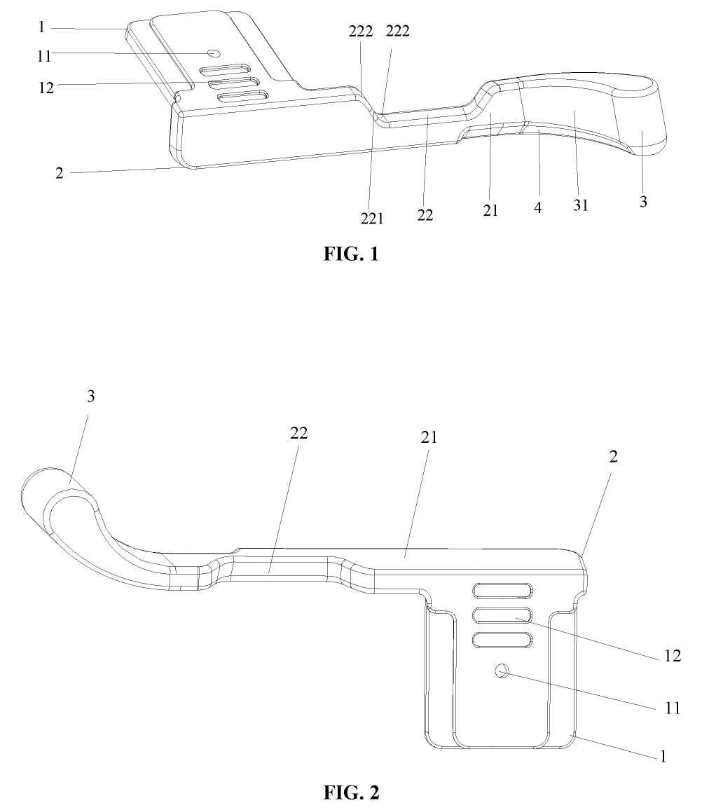

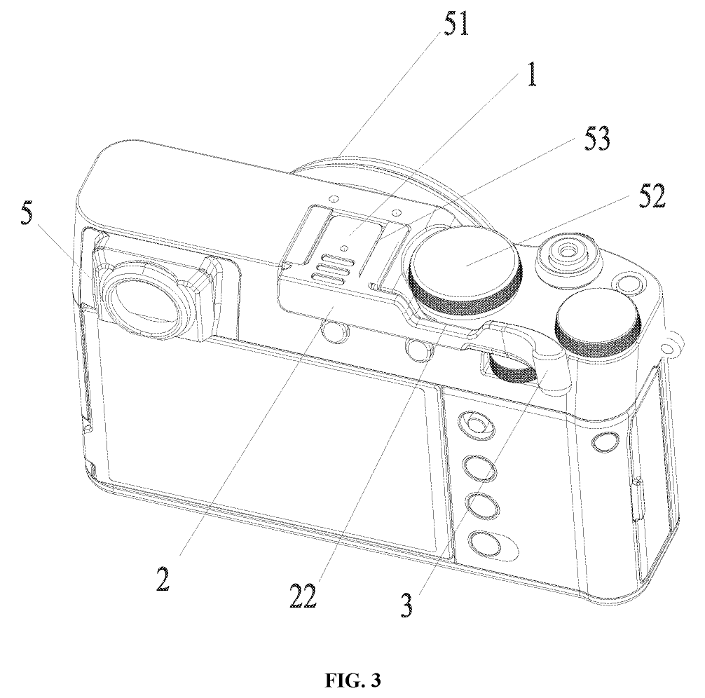

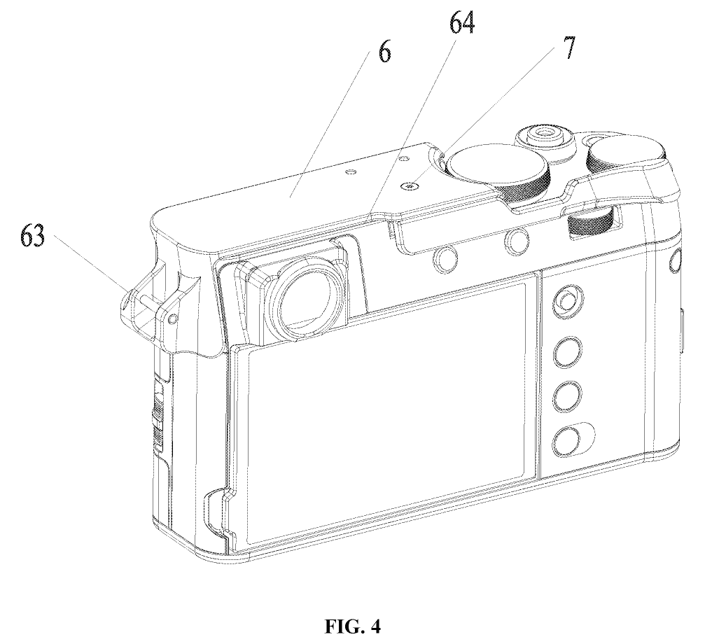

Referring to FIGS. 1-3, aspects of the disclosure provide a camera finger grip or a hand-grip device, including:

a mounting part 1 for attachment to a camera 5;

a connecting part 2, with its front side connected to the mounting part 1 and its rear side presenting a first contact surface 21 inclined towards the mounting part 1;

an arcuately shaped tail end part 3, fixedly positioned at the end of the connecting part 2 opposite the mounting part 1, featuring a second contact surface 31 inclined away from the mounting part 1, where the first contact surface 21 and the second contact surface 31 are interconnected.

In some aspects, the direction of the mounting part 1 corresponds to the direction of the lens 51 of the camera 5, while the direction away from the mounting part 1 indicates the user's position when using the camera 5. For example, the mounting part 1 can extend in a direction parallel to the optical axis of the camera lens. Given that the first contact surface 21 and the second contact surface 31 are inclined towards and away from the mounting part 1, respectively, when the camera finger grip is attached to the camera 5 via the mounting part 1 and the user operates the camera 5, their finger can slide over the second contact surface 31 of the tail end part 3 and rest diagonally on the first contact surface 21. Through the synergy of the second contact surface 31 and the first contact surface 21, the camera finger grip better conforms to the user's finger shape, providing superior support to fingers and enhancing user comfort.

In some aspects, the top surface of the connecting part 2 features a clearance groove 22 (e.g., a cutout) to prevent interference with the operation of the camera 5. For example, the clearance groove 22 can be designed to avoid the control element 52 (e.g., dial, knob, etc.) of the camera 5. With this clearance groove 22, the user's finger can slide along the first contact surface 21, pass through the clearance groove 22, and operate the control element 52 of the camera 5.

In some aspects, the clearance groove 22 is located between the mounting part 1 and the tail end part 3.

In some aspects, both sides of the clearance groove 22 can form inclined surfaces 221. For example, both ends of the inclined surface 221 are curved surfaces 222 to prevent discomfort when pressed against the user's finger.

In some aspects, the height of the tail end part 3 gradually increases from the end close to the connecting part 2 to the end away from the connecting part 2. For example, the tail end part 3 can extend in a fan shape or the like. This design allows the width of the second contact surface 31 to better conform to and wrap around the user's finger.

In some aspects, the bottom surface at the junction of the connecting part 2 and the tail end part 3 features a contoured contact surface 4. This contoured contact surface 4 can conform to the user's thumb web (the area between the thumb and index finger) to prevent discomfort when pressed against it by improving load distribution and reducing stress concentrations.

In some aspects, the mounting part 1 includes a hot shoe interface that enable the mounting part 1 to be directly inserted into the camera hot shoe interface 53 of the camera 5 for mounting the camera finger grip. The camera finger grip can also be called a hand-grip device or a handle grip in this disclosure.

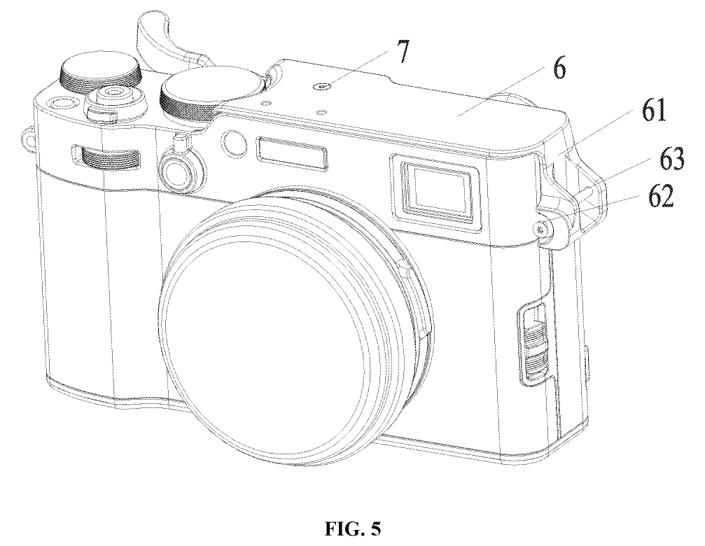

In some aspects, the top surface of the mounting part 1 features a threaded hole 11. In some aspects, this threaded hole 11 allows for the installation of additional accessories. For example, referring to FIGS. 4-5, a camera top plate 6 is shown. The camera top plate 6 further includes an upper side plate 61 fixed to the top plate 6. The upper side plate features a fifth contact surface for contacting the side surface of the camera. The upper side plate has a fixing position 62 for attachment to a camera holding hole (e.g., via a screw connection) to connect the upper side plate to the camera. The upper side plate also features a second holding hole 63 (e.g., a lug, eyelet) for facilitating the connection of a camera strap. In some aspects, the camera frame further includes a fixing member 7. The top plate features a third contact surface 64 for fitting and mounting on the top surface of the camera. The fixing member 7 is connected to the top plate 6 and the camera finger grip. In some aspects, the fixing member 7 can be a screw. The top plate 6 can also have a mounting hole, the mounting hole and threaded hole 11 are set in a one-to-one correspondence. The screw passes through the mounting hole in the top plate 6 and the threaded hole 11 in the camera finger grip to connect the top plate and the camera finger grip.

In some aspects, the top surface of the mounting part 1 features one or more sliding grooves (e.g., a sliding groove 12). When removing the camera finger grip from the camera hot shoe interface 53, a finger is pressed against the sliding groove 12 to push the camera finger grip. The sliding groove 12 increases friction, allowing the camera finger grip to be pushed out more quickly and conveniently. In some aspects , the sliding groove 12 is an elongated groove, and there may be multiple such grooves.

In some aspects, the camera finger grip is integrally formed. The camera finger grip can be made of titanium alloy or other suitable materials.

While the invention has been described with reference to specific embodiments, it will be understood by those skilled in the art that various changes and modifications may be made without departing from the spirit and scope of the invention as defined by the appended claims. The foregoing description of embodiments is provided for illustrative purposes only and is not intended to limit the invention. The scope of the invention is defined solely by the claims.

What is claimed is:

1. A camera finger grip, comprising:
a mounting part configured for mounting on a camera;
a connecting part, wherein a front side of the connecting part is connected to the mounting part;
wherein a rear side of the connecting part is provided with a first contact surface; and
wherein the first contact surface is inclined toward the mounting part;
a tail end part, wherein the tail end part is provided at an end of the connecting part away from mounting part;
wherein the tail end part is provided with a second contact surface;
wherein the second contact surface is inclined away from the mounting part; and
wherein the first contact surface and the second contact surface are connected.

2. The camera finger grip according to claim 1, wherein a top surface of the connecting part is provided with a clearance groove for avoiding interference with a camera control element.

3. The camera finger grip according to claim 2, wherein the clearance groove is located between the mounting part and the tail end part.

4. The camera finger grip according to claim 2, wherein opposite sides of the clearance groove are formed as inclined surfaces.

5. The camera finger grip according to claim 1, wherein a height of the tail end part gradually increases from an end adjacent to the connecting part to an end away from the connecting part.

6. The camera finger grip according to claim 1, further comprising a contoured contact surface at a junction between the connecting part and the tail end part.

7. The camera finger grip according to claim 1, wherein the mounting part comprises a hot shoe interface.

8. The camera finger grip according to claim 1, wherein a top surface of the mounting part is provided with one ore more sliding grooves.

9. The camera finger grip according to of claim 8, wherein the sliding groove is configured as elongated groove.

10. The camera finger grip according to claim 1, wherein the mounting part, the connecting part, and the tail end part are integrally formed as a single piece.

11. A camera frame, comprising a top plate, a fixing member, and the camera finger grip according to claim 1, wherein the top plate is provided with a third contact surface configured for mounting on a top surface of a camera; and
wherein the fixing member is connected to the top plate and the camera finger grip.

12. The camera frame of claim 11, wherein the mounting part is between the top plate and the camera.

13. A hand-grip device for a camera, comprising:
a mounting part configured to be received in and retained by a hot shoe of a camera;
a connecting part coupled to the mounting part; and
a tail end part located at a distal end of the connecting part opposite the mounting part, the tail end part having a grasping surface sized and shaped to be engaged by a user’s hand to improve grip of the camera.
